(19) United States
(12) Patent Application Publication
(10) Pub. No.: US 2012/0221309 A1
(43) Pub. Date: Aug. 30, 2012

(54) DEVICE AND METHOD FOR REGISTERING 3D MEASUREMENT DATA OF JAW MODELS IN A BASAL SKULL-REFERENCED COORDINATE SYSTEM WITH THE AID OF A COMPUTER-SUPPORTED REGISTRATION SYSTEM

(76) Inventor: RALF LAMPALZER, BOCHUM (DE)

(21) Appl. No.: 13/312,140

(22) Filed: Dec. 6, 2011

(30) Foreign Application Priority Data
Dec. 6, 2010 (EP) 100 15 321
Mar. 21, 2011 (EP) 11002329.8-2318

(51) Int. Cl. G06G 7/60

(52) U.S. Cl. 703/11

(57) ABSTRACT

An apparatus and method for use in the field of orthodontia and dental prosthodontics for registering 3D measurement data of a jaw model having a lower jaw model and an upper jaw model in a cranial-referenced coordinate system. The method and apparatus establish a spatial relationship between a cranium and the measurement data of the jaw models obtained from optical scanners. This is implemented by determining the spatial relationship between a paraocclusal spoon or a bite fork and jaw joints using a computer aided registering system, and by determining the spatial relationship between the paraocclusal spoon or the bite fork and the jaw model which provides locatable structures whose spatial relationship to the paraocclusal spoon or the bite fork is known.

### FIELD OF THE PRESENT INVENTION

The present invention generally relates to the field of orthodontia and to dental prosthodontics and related methods and apparatus.

### DESCRIPTION OF THE PRIOR ART

For orthodontia and dental prosthodontics jaw models are measured by means of optical 3D scanner devices and their shape is digitally detected.

In orthodontia and also in dental prosthodontics the reference of this data to the cranium 20 is required, as is schematically shown in FIG. 1. In particular the position of the temporomandibula joints or jaw joints 4 relative to the data of the jaw models is of importance. The masticatory system is based on the co-operation of the surface shape of the teeth (bumps, fissures) with the motion of the jaw joints. In dental prosthodontics therefore the surface shape of dental prosthesis may be calculated with superior efficiency when the position of the jaw joints is known. In the field of orthodontia improved diagnosis (“functional diagnosis”) and therapy may be applied when the position of the jaw joints is known.

Preliminary Remarks with Respect to Terminology
the jaw joints are of complicated shape, which is not required for the description of the present invention. The term “position of the jaw joint” is meant as an averaged anatomic position and orientation of the jaw joint, from which the jaw joint has due to its anatomy at least one and preferably several degrees of freedom with respect to motion.
the term “spatial relationship between two objects” is to be understood as follows. In each object there are defined a co-ordinate system and a co-ordinate origin. The spatial relationship between the object is mathematically the transformation of the co-ordinate systems of one object to the other object. The transformation consists of translation and rotation and may, for instance, be expressed by a translation vector having three components and three Euler angles.

Frequently, neither in orthodontia nor in prosthodontics the prosthesis or the orthodontic apparatus are manufactured completely on the basis of computer aided design, but are manufactured manually or with manual partial steps or manual control steps.

To this end, the jaw models are inserted into an articulator. An articulator is an apparatus which emulates the jaw joints by means of mechanical joints (which have additional clearance for typical joint movements).

In order to insert the jaw models at the correct position into the articulator the face bow or orthodontic headgear is taken. Upon removing the face bow it embodies mechanically the spatial relationship between the jaw joints and the teeth. By means of this mechanically embodied spatial relationship the models are placed in the articulator. This process is called “articulating of the models”. For the placement typically an amount of plaster is used, which is put between the models and the socket plate of the articulator. The system consisting of the articulator and the jaw models then emulates the masticatory system in a mechanical manner. The articulated models may be removed from the articulator, may be stored and may be reinserted in a reproducible manner.

Frequently there is a demand to establish a spatial relationship between the cranium and the measurement data of jaw models as are obtained from optical scanners.

Patent application DE 10 2008 060 504, patent document AT 507 887 B1 and patent document EP 1 105 067 B1 solve this technical problem by transferring the articulated models from the articulator in an optical 3D scanner, which comprises a socket within the scanner that is identical in construction to the socket in the articulator. The position of the socket in the scanner is known in the co-ordinate system of the 3D scanner. Since the socket in the articulator has a known cranial-referenced position the position of the joints of the articulator relative to the measurement data of the jaw models can be calculated.

This approach has the following disadvantages:
The process of articulating is a time-consuming manufacturing process.
The scanner has to accept jaw models which are fixed on an articulator socket. These objects are relatively big and heavy and have a relatively large variation with respect to the position of the model relative to the socket. The required scanner needs (i) an increased interior volume and (ii) generally a stronger mechanical construction for the motion of the big and heavy articulated models.

### DESCRIPTION OF COMPUTER AIDED REGISTERING SYSTEMS

In this approach, as will be described in the following, a “computer-aided registering system” is used. A computer-aided registering system is a further development of a face bow.

For example, the following computer-aided registering systems are available as products:

Axioquick (SAM Position Technology), Arcus Digma (KaVo), Cardiax (Girrbach), Condylocomp (Dentron), Freecorder (DDI Group). Literature: Dieter Schulz, Dr.-Olaf Winzen, “Basic Knowledge of Data Transfer”, teamwork media GmbH, 2004, ISBN 3-932599-16-0.

With continued reference to FIG. 1 a corresponding approach is schematically described by using a computer-aided registering system 28, wherein we agree on the following definitions: the upper part of the electronic registering system is connected sufficiently rigidly with the cranium 20 via soft tissue or teeth of the upper jaw. The upper part shall be denoted as “cranial-referenced component” indicated by reference sign 1.

The lower part of the computer-aided registering system shall be referenced as “lower jaw related component”. It is connected with the lower jaw. This connection is established by means of a spoon 5 attached to the lower jaw in a paraocclusal manner. The paraocclusal spoon 5 is attached to the lower jaw by means of a bite registering material 6, a composite or by means of any other appropriate material. The paraocclusal spoon 5 is separable from the lower jaw related component by a mechanical interface 8, that is, an adapter for the lower jaw related component.

In some but not all electronic registering systems (for example Arcus Digma) the lower jaw related component may additionally be connected to the upper jaw at any appropriate time. This is accomplished by means of a bite fork that is also indicated by reference sign 5, which is attached to the upper jaw by means of plaster or any other material. The bite fork, as well as the paraocclusal spoon, have to be adapted to the adapter for the lower jaw related component 8 and are inserted there in exchange with the paraocclusal spoon.

The electronic registering system 28 that at least comprises the components 1 and 2 has implemented therein a measurement method 3 (“measurement method of the electronic registering system”) in order to detect the position of the lower jaw related component 1 relative to the upper jaw related component 2 in spatial and angular degrees of freedom. This measurement method is realized in the described products by ultrasonic propagation measurements or by optical measurements. Hence, the electronic or computer aided registering system is implemented at least by the components 1, 2 and 3.

From the computer aided analysis of the motions of the lower jaw related component 1 relative to the cranial-referenced component 2 the positions of the jaw joints 4 are calculated in the co-ordinate system of the cranial-referenced component 1, typically including the above-mentioned further degrees of freedom of the jaw joints, which is accomplished by means of the computer aided registering system.

There are known two methods in order to determine the spatial relationship to the upper jaw:
A) In the registering system “freecorder” a null data recording is made with the measurement method 3 in a bite situation. Hence a “null position” of the lower jaw is recorded. The position of the upper jaw in this bite position may be taken from a bite registrate or bite registering.
B) In such registering systems which, as mentioned above, include the possibility to connect the under jaw related component 2 with the upper jaw, the spatial relationship with respect to the upper jaw is obtained by connecting the lower jaw related component 2 by means of the mentioned bite fork with the upper jaw and by taking a null data recording with the measurement method 3. The position and orientation of the lower jaw is irrelevant. The position of the upper jaw may be obtained from the bite fork with the hardened plaster or other material in combination with the null recording.

The present invention is based on the object to establish the spatial relationship between the cranium and the measurement data of jaw models as are obtained by optical scanners.

### SUMMARY OF THE INVENTION

According to one aspect the object is solved by a method for registering 3D measurement data of a jaw model comprising a lower jaw model and an upper jaw model in a cranial-referenced co-ordinate system. The method comprises:

Determining a first spatial relationship between one of a paraocclusal spoon and a bite fork, respectively, and jaw joints by means of a computer aided registering system. Moreover, the method comprises determining a second spatial relationship between the paraocclusal spoon or the bite fork, respectively, and the jaw model by using locatable structures whose spatial relationship to the paraocclusal spoon or the bite fork, respectively, is known. Furthermore the method comprises determining a third spatial relationship between the cranium and the jaw model in the cranial-referenced co-ordinate system by using the first and the second spatial relationships.

Further embodiments of the method are defined in the dependent claims.

According to a further aspect of the present invention the object is solved by an apparatus for registering 3D measurement data of a jaw model in a cranial-referenced co-ordinate system. The apparatus comprises a computer aided registering system configured to provide first measurement data for determination of a first spatial relationship between a paraocclusal spoon or a bite fork, respectively, and jaw joints. Furthermore, the apparatus comprises a dental 3D scanner configured to provide second measurement data for determination of a second spatial relationship between the paraocclusal spoon or the bite fork, respectively, and the jaw model by using locatable structures whose spatial relationship to the paraocclusal spoon or the bite fork is known. Furthermore, the apparatus comprises a computation and evaluation unit configured to determine a third spatial relationship between a cranium and the jaw model in the cranial-referenced co-ordinate system by using the first and second measurement data.

Further embodiments of the apparatus are described in the associated dependent claims.

According to a further aspect of the invention the object is solved by an adapter for use in an apparatus as described above, wherein the adapter provides structures locatable by a 3D scanner.

Further embodiments of the inventive adapter are defined in the associated dependent claims.

### BRIEF DESCRIPTION OF THE DRAWINGS

FIG. 1 schematically shows an apparatus of the present invention wherein the scanning is illustrated with an attached bite fork,

FIG. 2 schematically illustrates the configuration for scanning the bite fork in an elevated view and corresponding cross-sectional views,

FIG. 3 schematically illustrates an implementation of the bite fork according to an illustrative embodiment with vestibular locatable structures wherein an elevated view and corresponding cross-sectional views are illustrated,

FIG. 4 schematically illustrates an embodiment with lingual locatable structures with a connection behind the last molar tooth wherein an elevated view and corresponding cross-sectional views are illustrated,

FIG. 5 schematically illustrates a further illustrative embodiment with lingual locatable structures and frontal bridging wherein an elevated view and corresponding cross-sectional views are illustrated.

### DETAILED DESCRIPTION

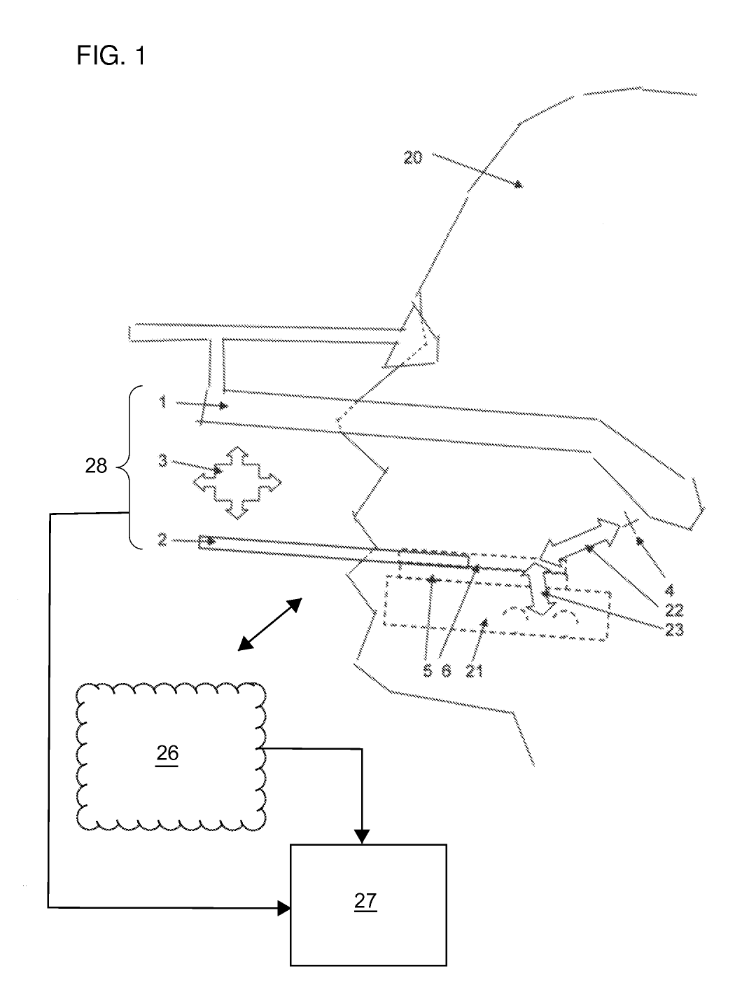

The present invention will now be described in more detail with reference to FIGS. 1-5.

Generally, the underlying object, ie. establishing the spatial relationship between cranium 20 and the measurement data of jaw models as are obtained from an optical scanner 26, may be solved by scanning the paraocclusal spoon and the bite fork, respectively, or by moulding locatable structures.

The present invention is based on the concept that, by means of the above-described computer aided analysis of motions, a first spatial relationship 22 is detected, which is also referred to as spatial relationship I, between the jaw joints 4 and the paraocclusal spoon or bite fork 5, and that, by means of a method to be described in the following paragraph, a second spatial relationship 23 is further established, which is also referred to as spatial relationship II, between the paraocclusal spoon 5 and the lower jaw or the lower jaw model 7. By associating the two relationships a third spatial relationship, ie. the spatial relationship between the jaw joints 4 and the lower jaw, made be calculated in an appropriate computation and evaluation unit 27. The spatial relationship with respect to the upper jaw may be taken from a bite registrate or bite registering. In FIG. 1 the process is schematically illustrated. For illustration purposes in cranium 20 a projected lower jaw model 21 is illustrated. It is to be noted that generally a jaw model is built up from a lower jaw model and an upper jaw model which are representatively denoted with reference sign 7, wherein for convenience a corresponding upper jaw model is not shown in the drawings.

One approach for determining the spatial relationship between the paraocclusal spoon and the lower jaw 23, for instance according to claim 2, is the method “scanning of the paraocclusal spoon”. At first, the optical scanner 26 scans the paraocclusal spoon 5 attached to the lower jaw model 7. The spoon is then removed without displacing the lower jaw model 7. In a further step the scanner then scans the lower jaw model itself. Since the lower jaw model has not been displaced, both scans are detected in the same co-ordinate system and the spatial relationship II 23 is detected.

In order to determine the spatial relationship between the upper jaw and the lower jaw any displacement is further avoided. A bite registrate or registering is attached, followed by the upper jaw (not shown). In a further step the scanner then scans the thus formed lower jaw-upper jaw pair. Since a displacement of the lower jaw model has not occurred both scans are in the same co-ordinate system.

The bite registrate is not necessary in some simple cases, in which a closed bite consists, since the bite situation is unambiguously determined by simply combining the two jaws in these cases. In other cases the bite registrate is required, hence the dental prosthesis has to be extended with respect to taking a bite registrate.

A further approach for the underlying object, for instance according to claim 3, is the method “scanning of the bite fork”. In this approach firstly the spatial relationship between the upper jaw and the bite fork is determined, which is also referred to in claim 3 as the second spatial relationship, and thereafter the relationship between upper jaw and lower jaw, referred to as the third spatial relationship in the claims, is determined. For determining the spatial relationship between the upper jaw and the bite fork the optical scanner firstly scans the upper jaw model attached to the bite fork. The bite fork is then removed without displacing the upper jaw model. In a further step the scanner scans the upper jaw model itself. Since a displacement of the upper jaw model has not occurred, both scans are described in the same co-ordinate system.

In order to determine the spatial relationship between the upper jaw and the lower jaw a displacement of the upper jaw is further avoided. A bite registrate is attached, followed by the lower jaw. In a further step the scanner then scans the thus formed lower jaw-upper jaw pair. Since the upper jaw model has not been displaced, both scans are in the same co-ordinate system.

In some simple cases, in which a closed bite is present, the bite registrate is not necessarily required since the bite situation is unambiguously represented by a simple combination of the two jaws in these cases. In other cases the bite registrate is required and hence the dental prosthesis has to be extended with respect to taking a bite registrate.

Possibly a reduced efficiency may be observed in the method “scanning of the paraocclusal spoon” and “scanning of the bite fork” since typically a paraocclusal spoon or a bite fork are not constructed in view of being scanned. Certain materials including metals are not very appropriate for optical scanning.

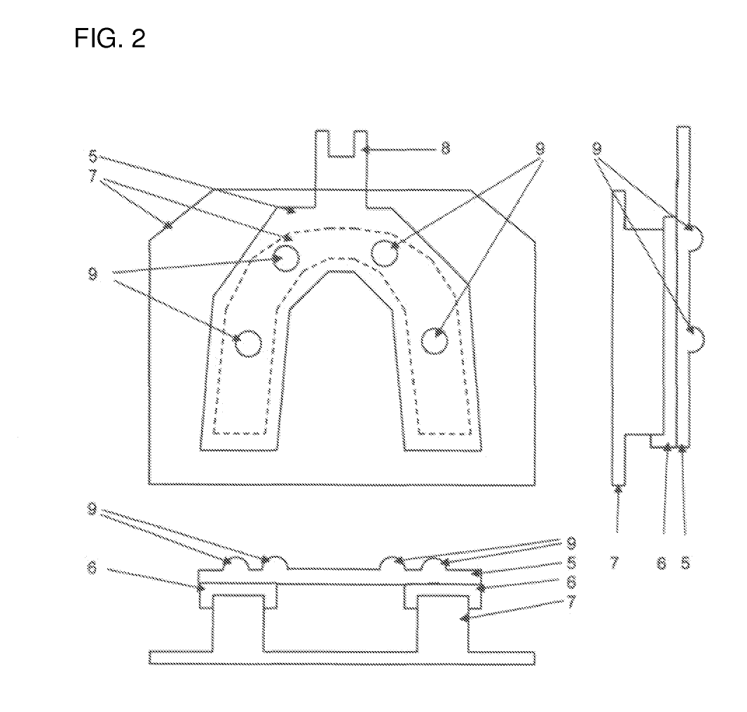

This problem may be solved by means of a paraocclusal spoon and a bite fork, respectively, which have certain occlusal-arranged locatable structures 9 that can be scanned (cf. FIG. 2).

By means of these structures, which are locatable by the scanner, the position of the paraocclusal spoon and of the bite fork, respectively, may be determined in all spatial degrees of freedom and all angular degrees of freedom. For example, matt white semi spheres may be integrated in a paraocclusal spoon or on the upper side of the bite fork. Three semi spheres are sufficient for determining the position, while four semi spheres would be redundant for the determination and would provide for superior accuracy. In all drawings four semi spheres are illustrated as an example for the locatable structures 9, 12 and 13 wherein, however, any other number may be used.

The above-described embodiments solve the problem, but may have the potential for improvements with respect to the following aspects:
the locatable structures have contact to the patient. They interfere with the patient's chewing motion. The structures have generally to be provided smaller compared to a situation when the patient is not to be taken into consideration in the shaping of the structures. Localization structures of increased size, however, allow a more precise localization in particular with respect to the angular degrees of freedom.
the process established by the dentist has to be changed. The stored paraocclusal spoons or bite forks may not need to be replaced with new modified pendants.

As a further development of the idea the locatable structures may be attached in a defined and reproducible manner to the paraocclusal spoon and the bite fork, respectively, only at the process of scanning. To this end, an appropriate adapter with form closure to the paraocclusal spoon or bite fork may be used.

A possible disadvantage of this solution would be the fact that a bite fork may possibly require additional place in the occlusal direction. In this case, an increased depth measurement range may be required compared to the situation when solely the jaw model has to be measured. Furthermore, a paraocclusal spoon as well as a bite fork require additional place in the frontal direction. Both facts may require the construction of a scanner of increased size.

It is advantageous to provide a specific adapter which may avoid this disadvantage:

One advantageous embodiment of the adapter has the following characteristics
it is made of a material that can be scanned (scannable adapter 13)
it has a form closure 18 with respect to the paraocclusal spoon and the bite fork, respectively. In this manner the spatial relationship is mechanically reproducible with small tolerances. The spatial relationship with respect to the paraocclusal spoon and the bite fork, respectively, is known due to the construction of the adapter.
it comprises locatable structures.
it is firmly connected to the lower jaw model and the upper jaw model, respectively, by means of a connecting material, preferably plaster, and hence the adapter remains attached to the model during the scanning, while on the other hand the paraocclusal spoon and the bite fork, respectively, are removed.

The transformation between the jaw joints and the lower jaw and the upper jaw, respectively, is calculated from the position of the locatable structures relative with respect to the scannable adapter and from the position of the scannable adapter relative with respect to the paraocclusal spoon and the bite fork, respectively.

This embodiment does not involve any of the disadvantages discussed so far. Furthermore, this embodiment has the advantage that the scannable adapter does not require contact to the patient. This simplifies the introduction of the technique and allows an superior selection of materials.

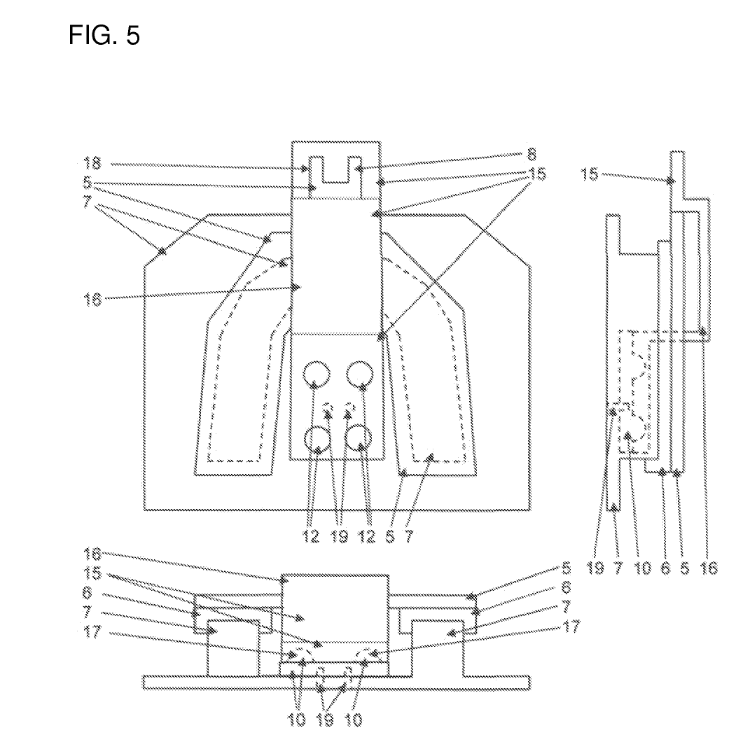

A further embodiment of the adapter (FIG. 5) uses a “mould adapter” 15. The method including a “mould adapter” is similar to the method involving a scannable adapter 13 of the above-described embodiment, however the structures are moulded in a connection material or mould material, preferably plaster material 10. The adapter does not remain attached to the model during the scan process but is removed together with the paraocclusal spoon and the bite fork, respectively. The plastic impression of the locatable structures 17 in the mould material is scanned.

The calculation of the (second) spatial relationship between the jaw joints and the lower jaw and the upper jaw, respectively, is accomplished by means of a spatial relationship of a plastic impression of the localization structures relative with respect to the paraocclusal spoon and the bite fork, respectively, obtained from the known construction of the mould adapter.

The embodiment including plastic impression has the following advantages compared to the embodiment with a scannable adapter.
The optical 3D scanning of plaster material is possible with superior accuracy compared to other surface areas. Hence, there is freedom with respect to the selection of materials for the adapter and materials with inferior characteristics with respect to the 3D scanning may be used, such as uncoated aluminium
The adapter is re-usable, it may be produced with reduced quantity and therefore it may be made of materials of superior quality and stiffness. In this manner, any errors caused by distortion of the adapter may be avoided.

The connection material including the plastic impression 17 may additionally be provided with a pin arrangement 19 with respect to the model plate. This is advantageous in that the plastic impression may be removed when it is not required.

### Form Closure

The adapter to the lower jaw related component is already constructed with form closure relative to the lower jaw bow. It is advantageous to use this construction feature and to provide the form closure for the adapter at this position.

### Arrangement of the Locatable Structures

There are two possibilities for the spatial arrangement of the structures relative with respect to the tooth row of the lower jaw and the upper jaw, respectively;

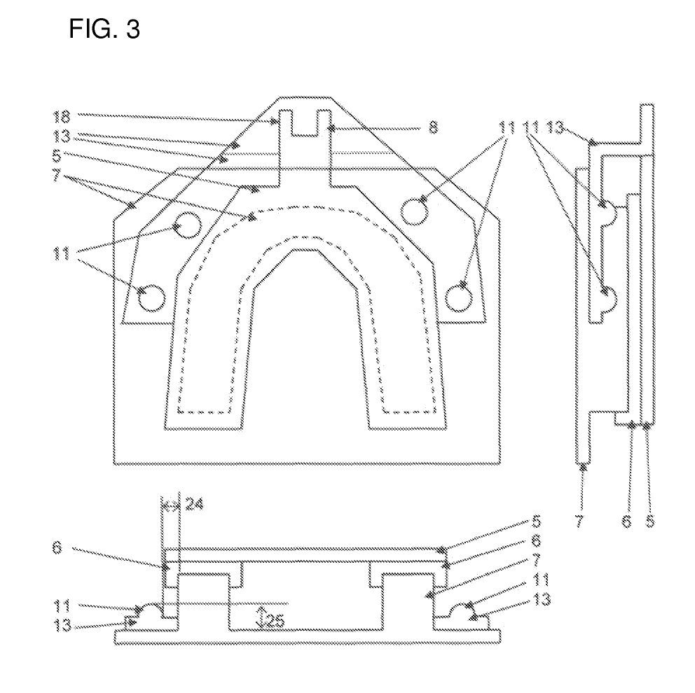

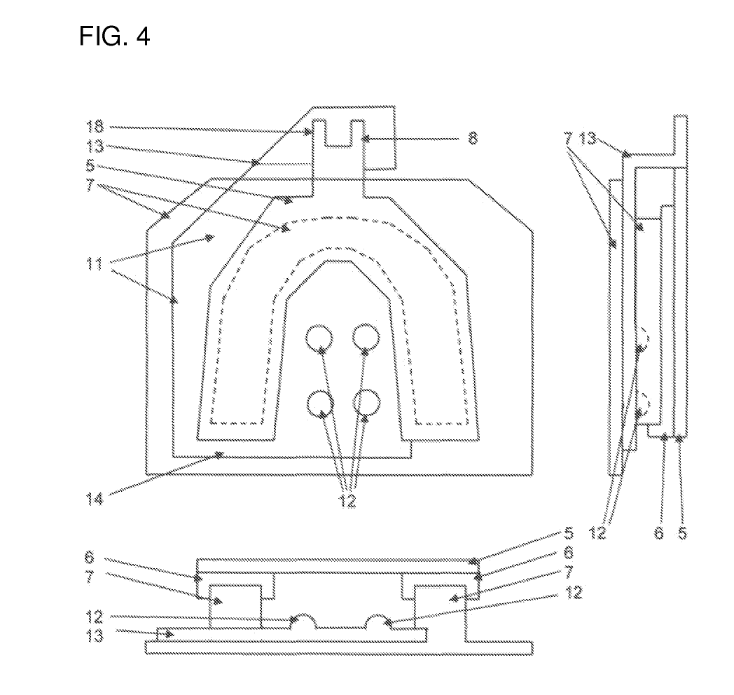

Arranging or positioning at the vestibular side or at the lingual side. Accordingly, vestibularly locatable structures 12 (FIG. 3) or lingually locatable structures 13 (FIG. 4) are to be distinguished.

Particularly advantageous is the usage of the lingual side: the locatable structures may be placed in the centre of the jaw bow and may be made relatively large in size. At the vestibular side, however, the measurement field of the scanner typically ends at small distance with respect to the tooth row.

The localization structures should not interfere with the scanning process. For this reason, the localization structures are to be provided with sufficient offset 24 from the tooth row and have a reduced height 25 such that the localization structures do not form a shadow at the tooth row during the scanning process.

An adapter that establishes the form closure to the paraocclusal spoon or to the bite fork at the vestibular side and has the structures at the lingual side may comprise a frontal bridging 16 (FIG. 5). In order that the bridge construction does not interfere during the scanning process the embodiment including the plastic impression has to be used. Alternatively a connection may be realized behind the last molar tooth 14 in the embodiment including a scannable adapter as well as in the embodiment including a plastic impression (FIG. 4).

Clarification with Respect to Chewing Motion and Virtual Articulator

A computer aided registering system is not only able to determine the (first) spatial relationship between the lower jaw and the cranial-referenced component in a bite position but also in any other position and orientation of a dynamic jaw motion, for instance a chewing motion. The considerations put forward above for determining the spatial relationship apply to the bite situation and also for any other point in time of a dynamic jaw motion.

### LIST OF TERMS USED IN THE DRAWINGS

1 Cranial-referenced component

2 Lower jaw related component

3 Measurement method

4 Position of the jaw joints

5 Bite fork

6 Plaster

7 Model of the lower jaw with model plate

8 Adapter for the lower jaw related component

9 Occlusal-positioned locatable structures

10 Connection material, preferably plaster

11 Vestibularly positioned locatable structures

12 Lingually positioned locatable structures

13 Scannable adapter

14 Connection behind the last molar tooth

15 Impression adapter

16 Frontal bridging

17 Plastic impression of the locatable structures

18 Form closure

19 Pin arrangement of the connection material including the model plate

20 Cranium or skull

21 Projected model of the lower jaw including locatable structures

22 Spatial relationship I between the jaw joints and paraocclusal spoon

23 Spatial relationship II between paraocclusal spoon and lower jaw

24 Sufficient distance

25 Reduced height

26 3D scanner

27 Computation and evaluation unit

28 Computer aided registering system

1-15. (canceled)

16. A method of registering 3D measurement data of a jaw model comprising a lower jaw model and an upper jaw model in a cranial-referenced co-ordinate system, comprising the steps of:
determining a first spatial relationship between jaw joints and one of a paraocclusal spoon and a bite fork by a computer aided registering system;
determining a second spatial relationship between the jaw model and one of the paraocclusal spoon and the bite fork by using locatable structures whose spatial relationship to one of the paraocclusal spoon and the bite fork is known; and
determining a third spatial relationship between a cranium and the jaw model in the cranial-referenced co-ordinate system by using the first and second spatial relationships.

17. The method according to claim 16, wherein the second spatial relationship is determined by the steps of:
modifying the lower jaw model by attaching a scannable adapter, which comprises a locatable structure, by forming a closure with the paraocclusal spoon;
establishing a connection between the lower jaw model and the scannable adapter;
removing the paraocclusal spoon;
scanning the modified lower jaw model;
determining the second spatial relationship between measurement data of the lower jaw model and the adapter; and
the third spatial relationship is determined by the steps of:
calculating the spatial relationship between the cranium and the measurement data of the lower jaw model from the first spatial relationship between the paraocclusal spoon and the jaw joints,
calculating a spatial relationship between the paraocclusal spoon and the scannable adapter known from the construction of the scannable adapter and
the determined spatial relationship between the measurement data of the lower jaw model and the scannable adapter; and
determining a spatial relationship between the upper jaw model and the lower jaw model by scanning the lower and upper jaw models combined in a bite situation.

18. The method according to claim 16, wherein the second spatial relationship is determined by the steps of:
modifying the upper jaw model by attaching a scannable adapter, which comprises locatable structures, by forming closure with the bite fork;
establishing a connection between the upper jaw model and the scannable adapter;
removing the bite fork;
scanning the modified upper jaw model;
determining the second spatial relationship between the measurement data of the upper jaw model and the scannable adapter;
a third spatial relationship is determined by the steps of:
calculating a spatial relationship between the cranium and the measurement data of the upper jaw model from
the first spatial relationship between the jaw joints and the bite fork;
using a spatial relationship between the bite fork and the scannable adapter known from the construction of the scannable adapter;
using the determined second spatial relationship between the measurement data of the upper jaw model and the scannable adapter;
determining a spatial relationship between the upper jaw model and the lower jaw model by scanning the upper and lower jaw models combined in a bite situation.

19. The method according to claim 16, wherein the second spatial relationship is determined by the steps of:
modifying a lower jaw model by attaching a mould adapter, which comprises the locatable structures, by forming closure to the paraocclusal spoon;
forming a plastic-impression of the locatable structures of the mould adapter onto the lower jaw model;
removing the paraocclusal spoon and the mould adapter;
scanning the modified lower jaw model;
determining a second spatial relationship between measurement data of the jaw model and the mould adapter by measuring structures plastic-impressed by the mould adapter;
the third spatial relationship is determined by the steps of:
calculating a spatial relationship between the cranium and the measurement data of the lower jaw model from
the first spatial relationship between the jaw joints and the paraocclusal spoon;
using a spatial relationship between the paraocclusal spoon and the mould adapter known from the construction of the mould adapter; and
using the determined spatial relationship between the measurement data of the lower jaw model and the mould adapter; and
determining a spatial relationship between the upper jaw model and the lower jaw model by scanning the upper and lower jaw models combined in a bite situation.

20. The method according to claim 16, wherein the second spatial relationship is determined by the steps of:
modifying the upper jaw model by attaching a mould adapter, which comprises the locatable structures, by forming closure to the bite fork;
forming a plastic impression of the locatable structures of the mould adapter onto the upper jaw model;
removing the bite fork and the mould adapter;
scanning the modified upper jaw model;
determining a second spatial relationship between measurement data of the upper jaw model and the plastic impression of the locatable structures;
the third spatial relationship is determined by the steps of:
calculating a spatial relationship between the cranium and the measurement data of the lower jaw model from
the first spatial relationship between the jaw joints and the bite fork;
using a spatial relationship between the bite fork and the mould adapter known from the construction of the mould adapter, and
the second spatial relationship; and
determining a spatial relationship between the upper jaw model and the lower jaw model by scanning the upper and lower jaw models combined in a bite situation.

21. An apparatus for registering 3D measurement data of a jaw model having jaw joints in a cranial-referenced co-ordinate system, comprising:
a computer aided registering system configured to provide first measurement data for determining a first spatial relationship between the jaw joints and one of a paraocclusal spoon and a bite fork;
a dental 3D scanner configured to provide second measurement data for determining a second spatial relationship between the jaw model and one of the paraocclusal spoon and the bite fork by using locatable structures whose spatial relationship to the one of paraocclusal spoon and the bite fork is known; and
a computation and evaluation unit configured to determine a third spatial relationship between a cranium and the jaw model in the cranial-referenced co-ordinate system using the first and second measurement data.

22. The apparatus according to claim 21, further comprising a scannable adapter that has the locatable structures and is attachable to the paraocclusal spoon.

23. The apparatus according to claim 21, further comprising a scannable adapter that has the locatable structures and is attachable to the bite fork.

24. The apparatus according to claim 21, further comprising a scannable adapter that has the locatable structures and is attachable to the paraocclusal spoon, and the scannable adapter is configured to enable a plastic impression of the locatable structures on a lower jaw model.

25. The apparatus according to claim 21, further comprising a scannable adapter that has the locatable structures and is attachable to the bite fork and enables forming a plastic impression of the locatable structures on an upper jaw model.

26. An adapter for use in an apparatus for registering 3D measurement data of a jaw model in a cranial-referenced co-ordinate system, comprising said adapter being configured for providing locatable structures that are locatable by a 3D scanner, and said adapter having a form closure relative to a paraocclusal spoon and a bite fork.

27. The adapter according to claim 26 being configured to be attached to said paraocclusal spoon.

28. The adapter according to claim 26 being configured to be attached to said bite fork.

29. The adapter according to claim 26 being configured to be attached to said paraocclusal spoon and to enable plastic impression of the locatable structures on a lower jaw model.

30. The adapter according to claim 26 being configured to be attached to a bite fork and to enable plastic impression of the locatable structures on an upper jaw model.
